(19) United States
(12) Patent Application Publication
(10) Pub. No.: US 2005/0149615 A1
(43) Pub. Date: Jul. 7, 2005

(54) System and method for processing resource registry updates without regard to chronological order

(76) Inventors: Joseph P. Nedimyer, Hillsborough, NC (US); Billy R. Rowe JR., Apex, NC (US); Steven J. Lee, Cary, NC (US)

Correspondence Address: COATS & BENNETT, PLLC, P O BOX 5, RALEIGH, NC, 27602, US

(21) Appl. No.: 10/738,482

(22) Filed: Dec. 17, 2003

(51) Int. Cl. G06F 15/16

(52) U.S. Cl. 709/202; 707/206

(57) ABSTRACT

The processing of management messages controlling resources and links in a resource repository may occur without regard to chronological order of the message creation. Resources and links include at least one timestamp, and a delete pending indicator. Messages to add, modify, and delete resources and links include a message timestamp. The management messages are conditionally processed based on a comparison between the message timestamp and the resource/link timestamp(s) and delete pending indicator. In an exemplary embodiment, AddResource, ModifyResource, DeleteResource, AddLink and DeleteLink messages are defined and their conditional processing described.

### BACKGROUND

The present invention relates generally to the field of software and in particular to applications that manage resources wherein resource registry updates may be processed without regard to chronological order.

The power of modern computing resources, and in particular very large databases, are increasingly being harnessed for the management of resources. Resources—physical or logical systems management entities—are collected into resource repositories. There, they are monitored and may be kept current with changes to the resources being managed and relationships or associations between the resources, represented as links between resources in the resource repository. The number of resources and links in such a repository can be very large, such as in the hundreds of thousands.

As one example, an organization's Information Technology (IT) resources may be managed in such a resource repository. The resources may include physical entities such as computers, servers, routers, and the like, as well as logical entities, such as instances of software, licensing arrangements, and the like. Links between the resources may represent actual communications links, thus mapping the topology of the IT system as well as maintaining its inventory, or logical relationships such as linking servers, printers, or other resources with compatible or accessible software, licenses, or the like. While the IT systems management application is utilized herein as an exemplary embodiment, applications maintaining resource repositories are not so limited. Such applications run from managing pumps and pipelines in an oil field to managing tanks and troops on the battlefield.

To maintain the coherency of the resource repository, prior art management applications perform repository population (the creation of resources and links in the repository) and maintain currency (adding new resources and links, and updating and deleting existing resources and links) in two ways. One method is batch loading the resources into the repository. This is a very time consuming process, and necessarily requires that the repository be “off line” or unavailable to applications while the repository is being updated/populated. Alternatively, a single software component may be dedicated to populate the repository or reflect the “delta” changes into the repository.

A significant bottleneck of prior art resource repositories and their management systems is that to maintain the proper “current” state of the repository (where the term current may refer to actual real-time, or to a snapshot at any given time), the repository requires a full repopulation, providing “delta” changes to the repository in the correct order. For example, a software module may be loaded onto a particular computer, later unloaded or otherwise disabled, and subsequently reloaded or re-enabled. If these updates—adding, deleting, and adding a resource to the resource repository—are not performed on the repository in the correct chronological order, erroneous or even nonsensical result may occur (such as for example creating multiple resources when only one is proper, or attempting to delete a resource that does not exist).

Another restriction of prior art resource repository management systems is that resources must be registered in the repository before the links that reference them. These processing requirements limit the concurrency potential of the repository. They also introduce a single point of failure—the single software module responsible for populating and updating the repository. In addition, the requirement of one software component to update the repository prohibits load balancing. Modern application frameworks, such as J2EE or Web services, implement load balancing by having multiple components process the data simultaneously. This not only enhances resource utilization, it eliminates a single point failure, and significantly enhances reliability.

### SUMMARY

A method of managing resources and bidirectional links between the resources in a resource repository comprises collecting and updating information regarding entities represented by the resources via a plurality of agents. The agents access the resource repository and conditionally add, modify, or delete the resources and/or links without regard to the chronological order of processing, in response to timestamps associated with the resources and links. In particular, the agents process management messages that contain a timestamp reflecting the time of message creation. The messages are conditionally processed if the message timestamp is later than the resource/link timestamp.

### BRIEF DESCRIPTION OF DRAWINGS

FIG. 1 is a flow diagram representation of the algorithm underlying an AddResource or ModifyResource message according to one embodiment of the present invention.

FIG. 2 is a flow diagram representation of the algorithm underlying a DeleteResource message according to one embodiment of the present invention.

FIG. 3 is a flow diagram representation of the algorithm underlying an AddLink message according to one embodiment of the present invention.

FIG. 4 is a flow diagram representation of the algorithm underlying a DeleteLink message according to one embodiment of the present invention.

### DETAILED DESCRIPTION OF THE INVENTION

The present invention relates to a system and method for processing registration events of a resource repository without regard to chronological order. That is, the chronological order of the generation of registration events is preserved, even when the messages or commands effecting the registration events are processed into the resource registry out of chronological order. As used herein, the phrase “without regard to chronological order” means that the processing of resource repository management messages need not necessarily occur in the same chronological order as their generation—not that the resource repository management messages disregard the chronological order of their generation. The present invention finds utility in both initially populating and in updating and maintaining currency of a resource repository. As used herein, the following terms are defined:

A resource refers to a physical or logical systems management entity that has management state and can be controlled and monitored by a management agent. A resource may include a plurality of attributes, which may vary depending on the type or class of resource. One such attribute may be an identifier or ID by which the resource is uniquely identified by management agents accessing the resource repository. A resource may also include one or more timestamps, and one or more flags that indicate predefined parameters or states. In particular, a resource may include a deletion pending flag.

A link is a bidirectional association between two resources. A link may represent a physical or a logical association between the resources. Like a resource, a link may include attributes, including a unique ID, and may include flags, including a delete pending flag.

The resource repository refers to the dynamic collection of managed resources (physical and/or logical manage entities) and links between the resources. In particular, according to the present invention, the resource repository may be managed—that is, resource and link registration requests may be received and processed by a software component—without regard to chronological order, where chronological order is defined as the order in which the resource and link registration requests were generated.

The present invention implements management of a resource repository by processing resource and link registration requests without regard to chronological order through a defined set of resource registration messages or commands, and the use of timestamps and status indicators. Each message includes a timestamp reflecting the time at which the message was generated (i.e., the time at which the resource or link registration event was requested by a management agent). By comparing the message timestamp value to the value of one or more timestamps maintained by the resources and links, and optionally additionally by referring to status maintained by the resources and links and reflected by the state of indicators or flags, the messages may be conditionally processed, thus maintaining the coherency of the resource registry when the messages are processed out of chronological order.

Additionally, resources and links that are deleted are not necessarily immediately removed from the registry; rather, they may assume a “delete pending” status, as reflected by a delete pending flag or other indicator. The resources and links in a delete pending state may be subsequently undeleted by an “add” or “modify” message with a timestamp subsequent to a timestamp of the resource or link that was set by a prior “delete” message. This operation may occur by removing the resource's or link's delete pending status, such as by altering its delete pending indicator or flag. Periodically, a “garbage collection” operation will actually remove resources and links that have been in a delete pending state for a sufficient time.

A representative set of resource and link registration event messages are summarized below, with a detailed description of the algorithms underlying each message to follow.

AddResource creates a resource and adds it to the resource repository. The message argument includes the ID of the resource to be added. Attributes from the message are transferred to the newly created resource in the resource repository. If the target resource already exists in the resource repository, the AddResource message updates its attributes.

UpdateResource updates the attributes of a resource in the resource repository. The message includes the ID of the resource to be updated. Attributes from the message are transferred to the corresponding resource in the resource repository. If the target resource does not already exist in the resource repository, UpdateResource creates it.

DeleteResource deletes a resource from the resource repository. The message includes the ID of the resource to be deleted. As described above, the delete resource message places a resource in delete pending state, and does not necessarily remove the resource from the resource repository. If the target resource does not already exist in the resource repository, DeleteResource creates a shell resource, and places it in a delete pending state.

AddLink creates a link between two resources in the resource repository. The message includes the ID of the link to be added. If either resource does not exist, it is added. If the target link already exists, AddLink updates its attributes.

DeleteLink deletes a link between two resources in the resource repository. The message includes the ID of the link to be deleted. The delete resource message places a link in delete pending state, and does not necessarily remove the link from the resource repository.

An implicit AddResource message is processed when a resource is identified as an endpoint in an AddLink message, and that resource does not already exist in the repository.

An implicit DeleteLink message is processed for each link in which a resource is participating when the resource is deleted by a DeleteResource message.

In processing an AddResource message, if the resource being added already exists in the resource repository, the AddResource message is treated as an UpdateResource message. Any links in which the resource is participating are not altered, but the attributes from the AddResource message are used to update the attributes of the corresponding resource in the resource repository.

In processing an AddLink message, if either the source or target resources associated with the link do not exist in the resource repository, the resources are first added to the resource repository using default values for any attributes. The attributes are subsequently updated by an AddResource or UpdateResource message.

Each of the messages includes a timestamp indicating when the message was generated. The timestamp is of sufficient granularity to ensure that no two messages will have the same timestamp.

According to the present invention, resources and links in the resource repository additionally include at least one timestamp, and at least a “delete pending” indicator. According to an exemplary embodiment of the present invention, the resources and links maintain the following data:

Modification TimeStamp: The modification timestamp maintains the time of the latest creation/modification of the resource or link. That is, the modification timestamp of a resource indicates the latest time of all previous AddResource and/or ModifyResource messages processed on that resource. Since an implicit AddResource message is processed when a resource is identified as an endpoint in an AddLink message and the resource does not already exist in the resource repository, the modification timestamp of the resource may be set to the AddLink message timestamp. The modification timestamp of a link is set to the latest timestamp of all previously processed AddLink messages associated with that link.

Deletion Timestamp: Resources and links in the resource repository maintain the time of latest deletion in the deletion timestamp. The deletion timestamp of a resource or link is set to the latest timestamp of all previous DeleteResource or DeleteLink messages processed on the respective resource or link. Since an implicit DeleteLink message is processed for each link in which a resource is participating when the resource is deleted, the deletion timestamp of a link may be set by the DeleteResource message. Otherwise, the deletion timestamp of a link is set to the latest timestamp of all previously processed DeleteLink messages associated with that link.

Delete Pending Indicator: Resources and links include an indicator, such as a flag, indicative of whether a DeleteResource or DeleteLink message has been processed on the resource or link. In other words, the indicator or flag indicates a delete pending state or status. Resources and links that are in a delete pending state are typically not considered active with regard to components accessing the resource repository.

The present invention is explicated herein with respect to the above-described exemplary embodiment. It will be readily apparent to one of ordinary skill in the art that separate modification and deletion timestamps, and a delete pending flag, are not strictly necessary. For example, resources and links could include a single timestamp and a delete pending flag. If the delete pending flag is false, the timestamp indicates the time of creation or latest modification. Conversely, if the delete pending flag is true, the timestamp indicates the time of latest deletion. As another example, separate modification and deletion timestamps may be necessary or desired, wherein the modification timestamp indicates the time of latest change of the resource or link attributes, independently of the time of deletion, which is maintained by the deletion timestamp. In this case, a delete pending flag is not strictly necessary, and delete pending state may be indicated by the presence of any non-zero value in the deletion timestamp. A variety of other specific implementations are possible within the scope of the present invention, as defined by the claims.

Over time, a buildup of resources and links in the delete pending state may occur. To support periodic cleanup of these entities, a garbage collection process is used whereby the resources and links in a delete pending state are examined and removed from the resource repository. The garbage collection process may optionally additionally examine the deletion timestamp, and remove only the resources and links that have “aged” significantly in a delete pending state. This may increase efficiency in the event of interleaved add and delete messages.

In general, according to the present invention, each management agent operating on the resource repository compares the message timestamp of a management message to the values of the modification timestamp and/or deletion timestamp of the target resource or link, and additionally examines the resource's or link's delete pending indicator. The agent conditionally processes its message function on the target resource or link in response to the timestamp(s) and/or delete pending indicator. If the target resource or link has a modification/deletion timestamp that exceeds (is later than) the message timestamp, the message is not processed (the target or link has already been processed by a later-generated message). If the modification/deletion timestamp of the target resource or link is less than (precedes) the message timestamp, the message is processed, and the resource's or link's timestamps are updated with the value of the message timestamp.

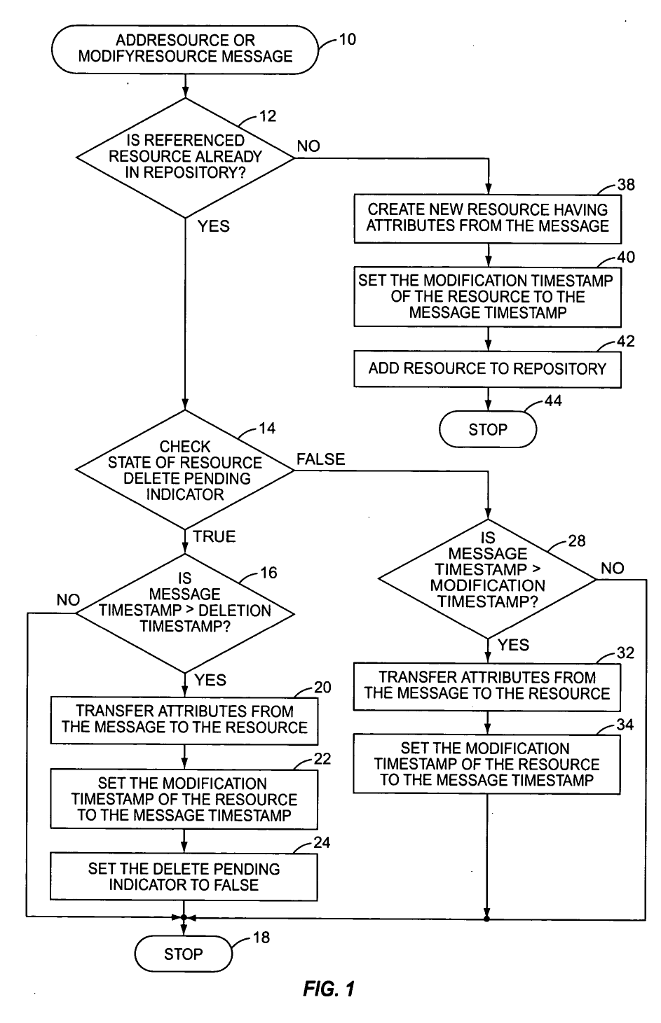

FIG. 1 depicts, in flow diagram form, the algorithm for adding a resource to the resource repository or modifying an existing resource within the resource repository, according to one embodiment of the present invention. The AddResource or ModifyResource message is generated at step 10 (in this exemplary embodiment, the same algorithm is executed for either management message). The resource repository is searched to ascertain whether the referenced resource, identified, for example, by a resource ID attribute, exists within the repository, at step 12. If so, at step 14 the delete pending indicator of the resource is inspected. If the delete pending indicator is true, i.e. the resource has previously been marked for deletion, the timestamp of the AddResource or ModifyResource message is compared to the deletion timestamp of the resource in the resource repository at step 16.

If the message timestamp is not greater than the deletion timestamp, i.e. if the AddResource of ModifyResource message precedes the message that marked the resource of deletion, processing of the AddResource or ModifyResource message terminates at step 18. Alternatively, if the message timestamp exceeds the deletion timestamp, i.e., the AddResource or ModifyResource message was generated after the message that deleted the resource, then the attributes are transferred from the AddResource or ModifyResource message to the target resource at step 20. The modification timestamp of the target resource is set to the timestamp of the AddResource or ModifyResource message at step 22. Finally, the delete pending indicator of the resource is set to false, and processing of the AddResource or ModifyResource message terminates at step 18.

If, at step 14, the delete pending indicator of the target resource is false (i.e., the resource is not marked for deletion), then the message timestamp is compared to the modification timestamp of the resource at step 28. If the message timestamp does not exceed the resource's modification timestamp (i.e., the AddResource or ModifyResource message was generated prior to the last message that operated on the resource), the message processing terminates at step 18. If the message timestamp exceeds the resource's modification timestamp (i.e., the AddResource or ModifyResource message was generated after the last message that operated on the resource), then the message attributes are transferred from the AddResource or ModifyResource message to the target resource in the resource repository at step 32. The modification timestamp of the resource is updated to the message timestamp at step 34, and processing of the AddResource or ModifyResource message is complete, and terminated at step 18.

If, at step 12, the referenced resource is not found in the resource repository, a new resource is created, and attributes from the AddResource or ModifyResource message are transferred to the newly created resource, at step 38. The modification timestamp of the newly created resource is updated to the message timestamp at step 40. The newly created resource is then added to the resource repository at step 42, and processing of the AddResource or ModifyResource message terminates at step 44.

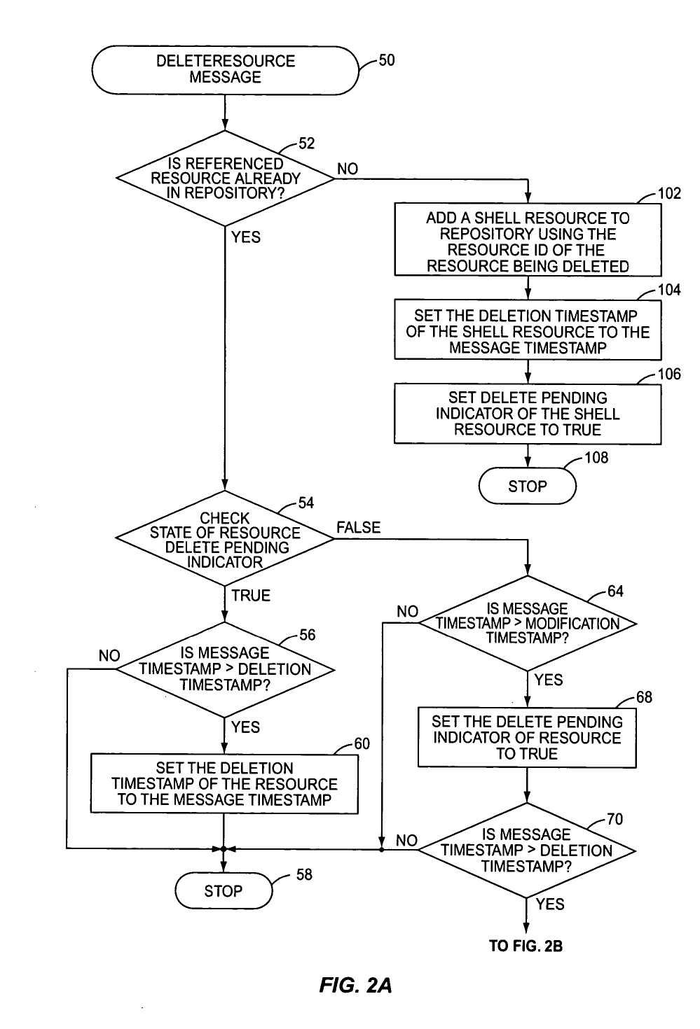

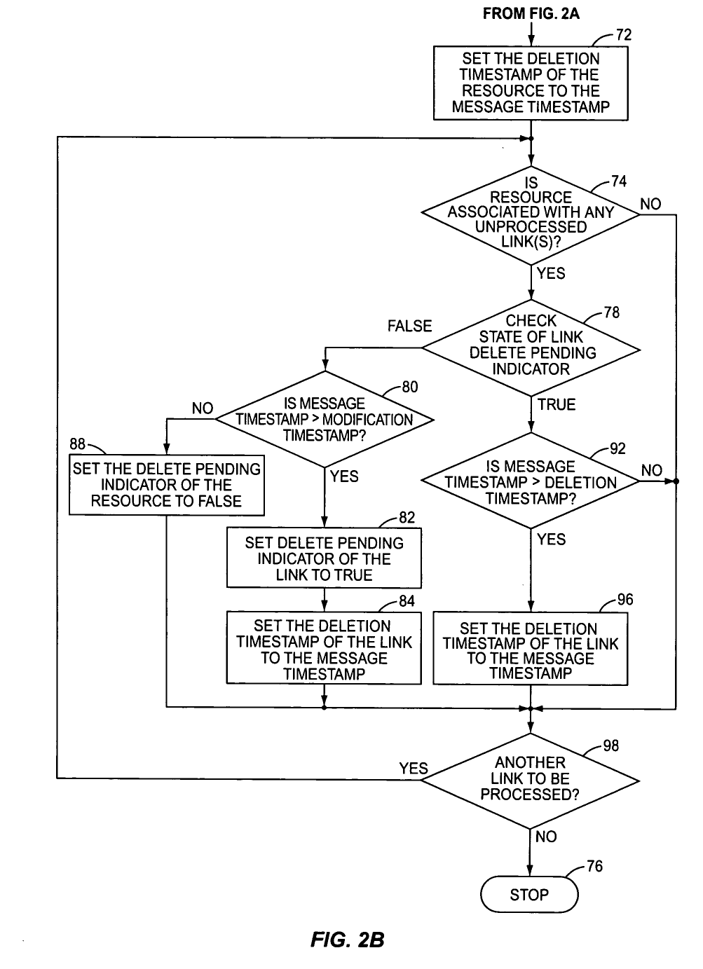

FIG. 2 depicts the algorithm underlying the DeleteResource message. As previously noted, resources are not immediately deleted from the resource repository; rather, they are marked for later deletion. This allows for efficient implementation of interleaved management messages, such as DeleteResource message followed by a ModifyResource message targeted to the same resource.

The DeleteResource message processing begins at step 50, and proceeds with a search to determine whether the reference resource (referenced, e.g., by an ID attribute associated with the resource) exists within the resource repository, at step 52. If the referenced resource exists, its deletion state is checked via the delete pending indicator at step 54. If the delete pending indicator is true, i.e., the resource has already been marked for deletion, the DeleteResource message timestamp is compared to the resource deletion timestamp at step 56. If the message timestamp does not exceed the resource deletion timestamp (i.e., the DeleteResource message precedes the message that deleted the resource) then the DeleteResource message processing terminates at step 58, with no resource attributes updated. Alternatively, if the message timestamp exceeds the resource deletion timestamp at step 56 (i.e., the current DeleteResource message is later than a previous delete resource message) then the deletion timestamp of the target resource is updated to the DeleteResource message timestamp at step 60, and the message processing then ends at step 58.

If the target resource is not already marked for deletion, as indicated by the delete pending indicator at step 54 being false, then the DeleteResource message timestamp is compared to the resource modification timestamp at step 64. If the message timestamp does not exceed the modification timestamp (i.e., the DeleteResource message precedes another message that modified the resource) then the DeleteResource message processing terminates at step 58. If the message timestamp exceeds the resource modification timestamp at step 64, then the resource is marked for deletion at step 68 by setting the delete pending indicator to true. The DeleteResource message timestamp is then compared to the resource's deletion timestamp at step 70. If the message timestamp does not exceed the deletion timestamp, then the DeleteResource message processing terminates at step 58. If the message timestamp exceeds the deletion timestamp, then the deletion timestamp of the resource is updated to the delete resource message timestamp at step 72.

The DeleteResource message then proceeds to process any links associated with the resource, at step 74. For each link, the deletion status of the link is determined by checking the link's delete pending indicator at step 78. If the link is not already marked for deletion (i.e., if the link delete pending indicator is false) then the message timestamp is compared to the link's modification timestamp at step 80. If the message timestamp exceeds the link modification timestamp, the delete pending indicator of the link is set to true at step 82, the deletion timestamp of the link is updated to the DeleteResource message timestamp at step 84, and the DeleteResource message processing terminates for that link and the target resource is then checked at step 98 to ascertain if additional links should be processed.

If, at step 80, the message timestamp does not exceed the link's deletion timestamp (i.e., the current DeleteResource message was generated prior to another operation that cleared the link's delete pending indicator), then the delete pending indicator of the target resource is set to false at step 88, and the DeleteResource message processing terminates for that link and the target resource is then checked at step 98 to ascertain if additional links should be processed. That is, if a later-generated message created or modified the link, the associated resources (including the target resource) were concurrently created or modified. Hence, the current DeleteResource message has been superceded, and the target resource should not be deleted.

If, at step 78, the link was marked for deletion, then the DeleteResource message timestamp is compared to the link's deletion timestamp at step 92. If the current message precedes the message that marked the link for deletion, then the message processing terminates for that link and the target resource is then checked at step 98 to ascertain if additional links should be processed. Alternatively, if the message timestamp exceeds the link's deletion timestamp, then the deletion timestamp of the link is updated to the DeleteResource message timestamp at step 96. The target resource is then checked at step 98 to ascertain additional links, and each remaining link is processed similarly.

Finally, if the referenced resource does not exist in the resource repository at step 52, the DeleteResource message will add a shell resource to the repository, with the resource ID of the resource that was targeted for deletion, at step 102. The deletion timestamp of the shell resource is set to the DeleteResource message timestamp at step 104, the delete pending indicator of the shell resource is set to true at step 106, and the DeleteResource message processing then terminates at step 108.

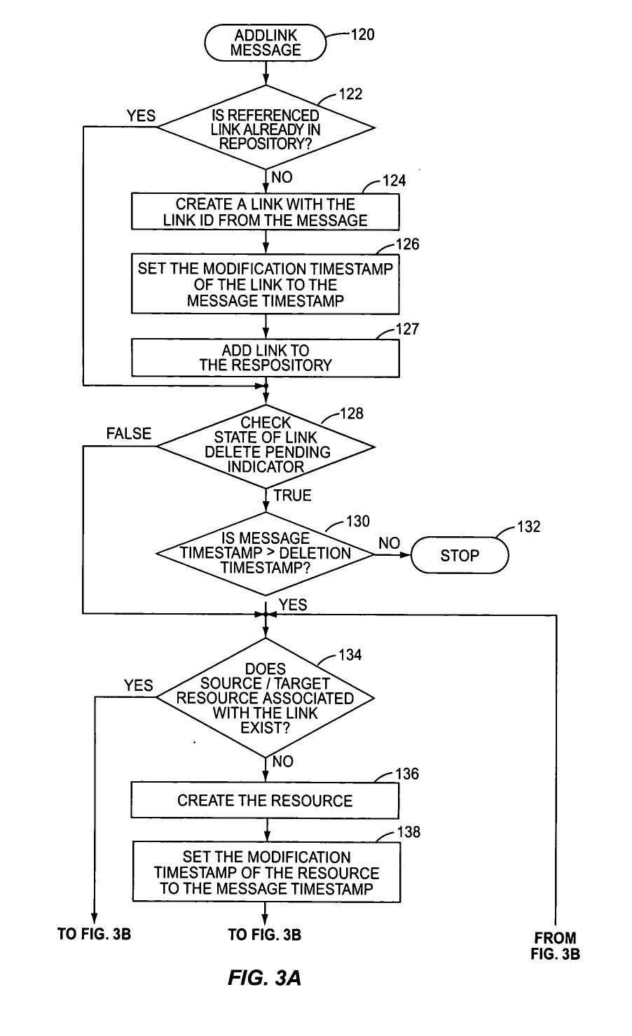

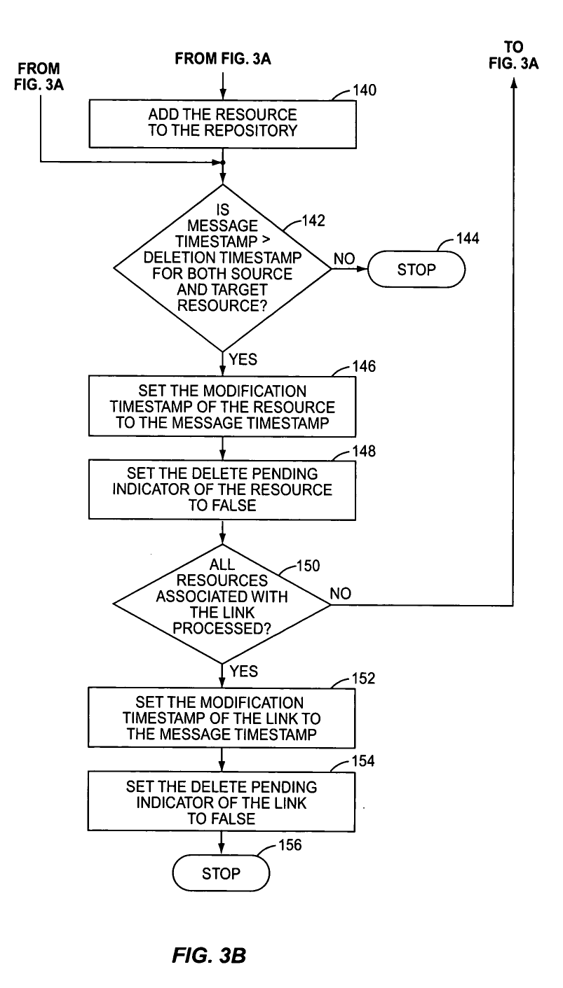

FIG. 3 depicts the algorithm underlying the processing of the AddLink message, beginning at step 120. The resource repository is searched at step 122 to ascertain whether the referenced link exists in the repository. If the referenced link does not already exist, a new link is created with the link ID from the AddLink message, at step 124. The modification timestamp of the link is set to the AddLink message timestamp at step 126.

If the referenced link was found in the resource repository at step 122 (or alternatively was created at steps 124 and 126) the deletion status of the link is checked at step 128 by inspecting the link delete pending indicator. If the delete pending indicator is true the AddLink message timestamp is compared to the link deletion timestamp at step 130. If the message timestamp does not exceed the deletion timestamp (i.e., if the AddLink message was generated prior or to a message that deleted the link), the AddLink message processing terminates at step 132. If the link delete pending indicator at step 128 is false (or alternatively if the delete pending indicator is true and the AddLink message timestamp exceeds the link deletion timestamp) then the existence of both a source and target resource associated with the link is checked at step 134.

If either the source or target resource does not exist, it is created at step 136. The modification timestamp of the newly created resource is set to the AddLink message timestamp at step 138, and the resource is added to the resource repository at step 140. If both the source and target resources associated with the link exist (either discovered at step 134 or created through steps 136,138 and 140) then the AddLink message timestamp is compared to the deletion timestamps for both the source and target resources at step 142. If the AddLink message was generated prior to a message that deleted either source or target resource, then the AddLink message processing terminates at step 144. If the AddLink message timestamp exceeds the deletion timestamp for both source and target resource, then the modification timestamp of the resources are set to the AddLink message timestamp at step 146. The delete pending indicator for both resources is set to false at step 148. The resource processing continues for both the source and target resource associated with the link, as indicated at step 150. Once all associated resources have been processed, the modification timestamp of the link is set to the AddLink message timestamp at step 152. The delete pending indicator of the link is set to false at step 154, and the AddLink message processing terminates at step 156.

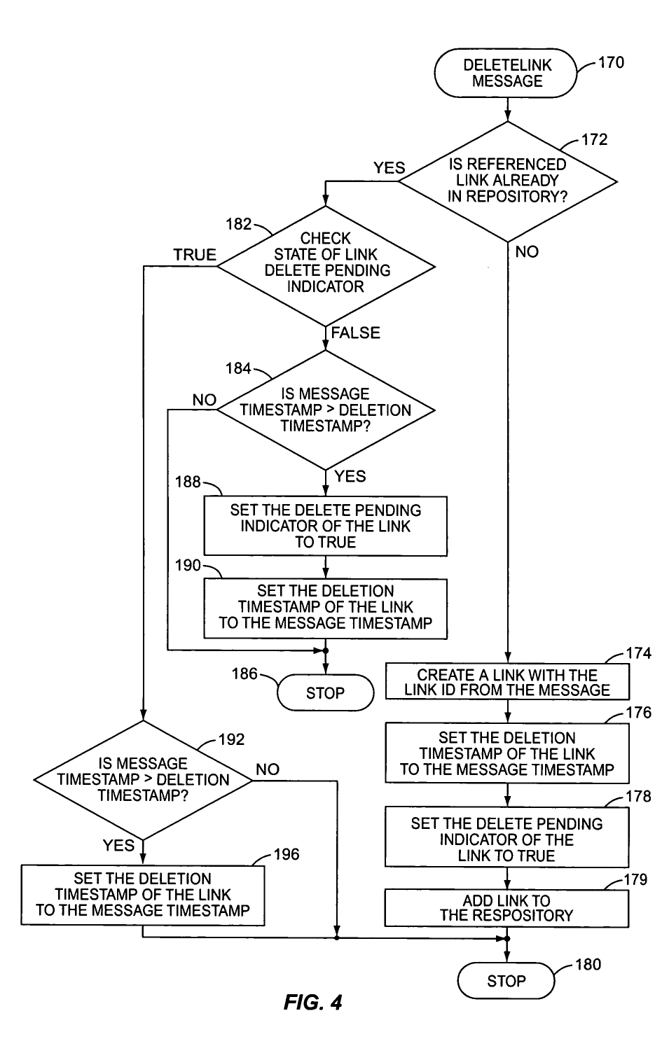

FIG. 4 depicts the algorithm underlying the DeleteLink message processing, beginning at step 170. Initially, the repository is searched to determine whether the referenced link already exists, at step 172. If the referenced link does not exist, a link with the link ID from the DeleteLink message is created at step 174. The deletion timestamp of the link is set to the DeleteLink message timestamp at step 176. The delete pending indicator of the link is set to true at step 178, the link is added to the resource repository at step 179, and the DeleteLink message processing terminates at step 180.

If, at step 172, the referenced link is found in the resource repository, then the deletion status of the link is checked at step 182 by examining the link delete pending indicator. If the link is not marked for deletion, the DeleteLink message timestamp is compared to the link deletion timestamp at step 184. If the DeleteLink message precedes the latest message to delete the link, then the DeleteLink message processing terminates at step 186. Alternatively, if the DeleteLink message timestamp exceeds the deletion timestamp of the link, the delete pending indicator of the link is set to true at step 188, and the deletion timestamp of the link is updated to the DeleteLink message timestamp at step 190. The DeleteLink message processing then terminates at step 186.

If the link is already marked for deletion as indicated at step 182, then the DeleteLink message timestamp is compared to the link deletion timestamp at step 192. If the DeleteLink message precedes a message that deleted the link, then the DeleteLink message processing terminates at step 180. If the DeleteLink message timestamp exceeds the link deletion timestamp, then the link deletion timestamp is updated to the message timestamp at step 196, and the DeleteLink message processing terminates at step 180.

By processing resource and link management messages according to the present invention, resource repository management agents may create, update, and delete resources and links without regard to the chronological order of the management messages' creation. This allows for multiple, concurrent management agents to access and operate on the resource repository concurrently, which increases reliability by eliminating a single-point failure, and allows load balancing of the management agents. Additionally, the availability of the resource repository is improved, as all access to the repository need not be periodically halted pending an update or repopulation of the resources and links.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of managing resources and bidirectional links between said resources in a resource repository, comprising:
(1) collecting and updating information regarding entities represented by said resources via a plurality of agents;
(2) accessing said resource repository by said agents; and
(3) conditionally adding, modifying, or deleting said resources and/or links by said agents without regard to chronological order, in response to timestamps associated with said resources and links.

2. The method of claim 1 wherein conditionally adding, modifying, and deleting said resources and links comprises conditionally processing resource repository messages, each said message including a message timestamp.

3. The method of claim 2 wherein conditionally processing resource repository messages comprises processing said messages if said message timestamp exceeds said resource or link timestamp, and not processing said messages if said message timestamp does not exceed said resource or link timestamp.

4. The method of claim 3 wherein processing said messages if said message timestamp exceeds said resource or link timestamp includes updating said resource or link timestamp to said message timestamp value.

5. The method of claim 2 wherein each said resource and link in said repository includes a modification timestamp and a deletion timestamp.

6. The method of claim 5 wherein each said resource and link in said repository additionally includes a delete pending indicator.

7. The method of claim 6 wherein conditionally deleting each said resource or link comprises, if the resource or link delete pending indicator is false and if the delete message timestamp exceeds the resource or link modification timestamp, setting the delete pending indicator to true and updating the deletion timestamp of the resource or link to the value of the delete message timestamp.

8. The method of claim 7 further comprising periodically performing a garbage collection operation wherein resources and links whose delete pending indicators are true are removed from said resource repository.

9. The method of claim 1 wherein conditionally adding a link includes conditionally adding a resource as an endpoint of said link if said resource does not exist in said repository.

10. The method of claim 1 wherein conditionally deleting a resource includes conditionally deleting each link associated with said resource.

11. A method of processing, without regard to chronological order, an AddResource or ModifyResource message having a message timestamp and resource attributes, in a resource repository including resources and bidirectional links between said resources, said resources and links having attributes, at least one timestamp and a delete pending indicator, comprising:
(1) determining if the resource referenced by said AddResource/ModifyResource message is already in said repository;
(A) if said resource is already in said repository, and if said message timestamp exceeds a timestamp of said resource:
(i) transferring said resource attributes from said message to said resource;
(ii) setting a timestamp of said resource to said message timestamp value; and
(iii) if the delete indicator of said resource is true,
(a) setting said delete pending indicator to false;
(B) if said resource is not already in said repository:
(i) creating a new resource in said repository having the resource attributes of said message; and
(ii) setting a timestamp of said resource to said message timestamp value.

12. A method of processing, without regard to chronological order, a DeleteResource message having a message timestamp and resource attributes, in a resource repository including resources and bidirectional links between said resources, said resources and links having attributes, at least one timestamp and a delete pending indicator, comprising:
(1) determining if the resource referenced by said DeleteResource message is in said repository;
(A) if said resource is in said repository, and if said message timestamp exceeds a timestamp of said resource:
(i) setting a timestamp of said resource to said message timestamp value;
(ii) if the delete pending indicator of said resource is false:
(a) setting said delete pending indicator to true; and
(b) processing all links associated with said resource;
(B) if said resource is not in said repository,
(i) creating a shell resource in said repository;
(ii) setting a timestamp of said shell resource to said message timestamp value; and
(iii) setting the delete pending indicator of said shell resource to true.

13. The method of claim 12, wherein processing links associated with said resource comprises, for each said link:
(1) if said message timestamp exceeds a timestamp of said link:
(A) setting a timestamp of said link to said message timestamp value; and
(B) if the delete pending indicator of said link is false,
(i) setting the delete pending indicator of said link to true;
(2) if said message timestamp is less than a timestamp of said link and the delete pending indicator of said link is false,
(A) setting the delete pending indicator of the said resource to true.

14. The method of claim 13, further comprising periodically performing a garbage collection operation wherein resources and links whose delete pending indicators are true are removed from said resource repository.

15. A method of processing, without regard to chronological order, an AddLink message having a message timestamp and link attributes, in a resource repository including resources and bidirectional links between said resources, said resources and links having attributes, at least one timestamp and a delete pending indicator, comprising:
(1) determining if the link referenced by said AddLink message is already in said repository;
(A) if said resource is not in said repository, creating a link in said repository with a timestamp having the value of said message timestamp;
(2) if said message timestamp exceeds a link timestamp:
(B) setting a timestamp of said link to said message timestamp value;
(3) determining the resources associated with said link; and
(4) processing said resources.

16. The method of claim 15, wherein processing said resources comprises, for each said resource associated with said link:
(1) if said resource does not exists in said repository:
(A) creating a resource in said repository with a timestamp having the value of said message timestamp;
(2) if said message timestamp exceeds a resource timestamp
(A) setting a timestamp of said resource to said message timestamp value;
(B) if a delete pending indicator of said resource is true:
(i) setting said delete pending indicator to false.

17. A method of processing, without regard to chronological order, a DeleteLink message having a message timestamp and link attributes, in a resource repository including resources and bidirectional links between said resources, said resources and links having attributes, at least one timestamp and a delete pending indicator, comprising:
(1) determining if the link referenced by said DeleteLink message is in said repository;
(A) if said link is in said repository, and if said message timestamp exceeds a timestamp of said link:
(i) setting a timestamp of said link to said message timestamp value;
(ii) if the delete pending indicator of said link is false:
(a) setting said delete pending indicator to true;
(B) if said link is not in said repository,
(i) creating a link in said repository;
(ii) setting a timestamp of said link to said message timestamp value; and
(iii) setting the delete pending indicator of said link to true.
